(19) United States
(12) Patent Application Publication
(10) Pub. No.: US 2009/0177558 A1
(43) Pub. Date: Jul. 9, 2009

(54) Methods and apparatus for wireless interactive guided shopping

(76) Inventor: Robert Sohrab Showghi, Encinitas, CA (US)

Correspondence Address: Robert S. Showghi, 2223 El Camino Del Norte, Encinitas, CA, 92024, US

(21) Appl. No.: 12/319,683

(22) Filed: Jan. 9, 2009

Related U.S. Application Data
(60) Provisional application No. 61/010,439, filed on Jan. 9, 2008.

(51) Int. Cl. G06Q 30/00

(52) U.S. Cl. 705/27

(57) ABSTRACT

The disclosed embodiments provide for methods and apparatus for a user of a wireless handset device to wirelessly connect to a portal of a merchant/vendor, or a third party service provider and interactively select and purchase food ingredients and merchandise assembly parts. The user may also receive instructions on how to select recipes, choose ingredients, pick up ingredients, prepare and cook the meal. The inventive concept may also be applied to assembly of other merchandise, such as toys, home improvement, home projects, clothing, costumes, party design and furnishing, and other projects.

### CLAIM OF PRIORITY UNDER 35 U.S.C. §119

The present Application for Patent claims priority to Provisional Application No. 61/010,439 entitled “Method and Apparatus for Wireless Interactive Shopping List Generation, Mobile Commerce Purchasing, and Wireless Interactive Guided Shopping” filed Jan. 9, 2008, and hereby expressly incorporated by reference herein.

### BACKGROUND

### Field

The disclosed subject matter relates to wireless commerce, specifically to wireless interactive guided shopping. More specifically, it relates to wireless interactive shopping for food preparation and merchandise assembly.

### BRIEF DESCRIPTION OF THE DRAWINGS

FIG. 1 is a flow diagram of the disclosed embodiments; and

FIG. 2 is a block diagram for the disclosed embodiments.

### DETAILED DESCRIPTION

The disclosed embodiments provide for methods and apparatus for a user of a wireless handset device to wirelessly connect to a portal of a merchant/vendor, or a third party service provider, and interactively select and purchase food and ingredients and merchandise assembly parts. The user may also receive instructions on how to select recipes, choose ingredients, pick up ingredients, prepare and cook the meal. The inventive concept may also be applied to assembly of other merchandise, such as toys, home improvement, home projects, clothing, costumes, party design and furnishing, and other projects.

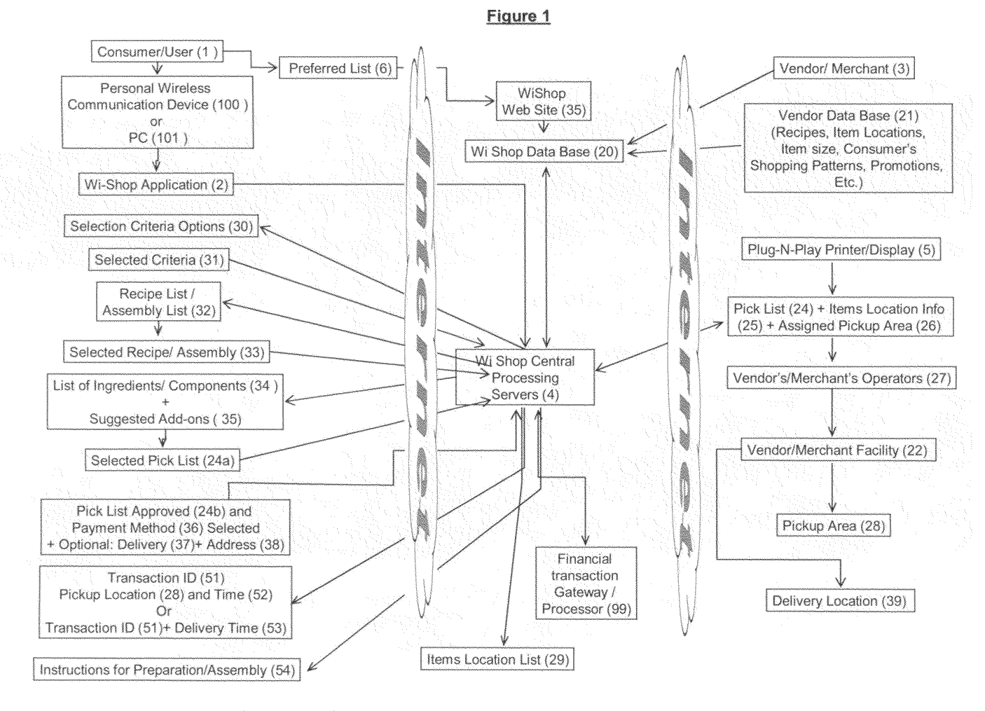

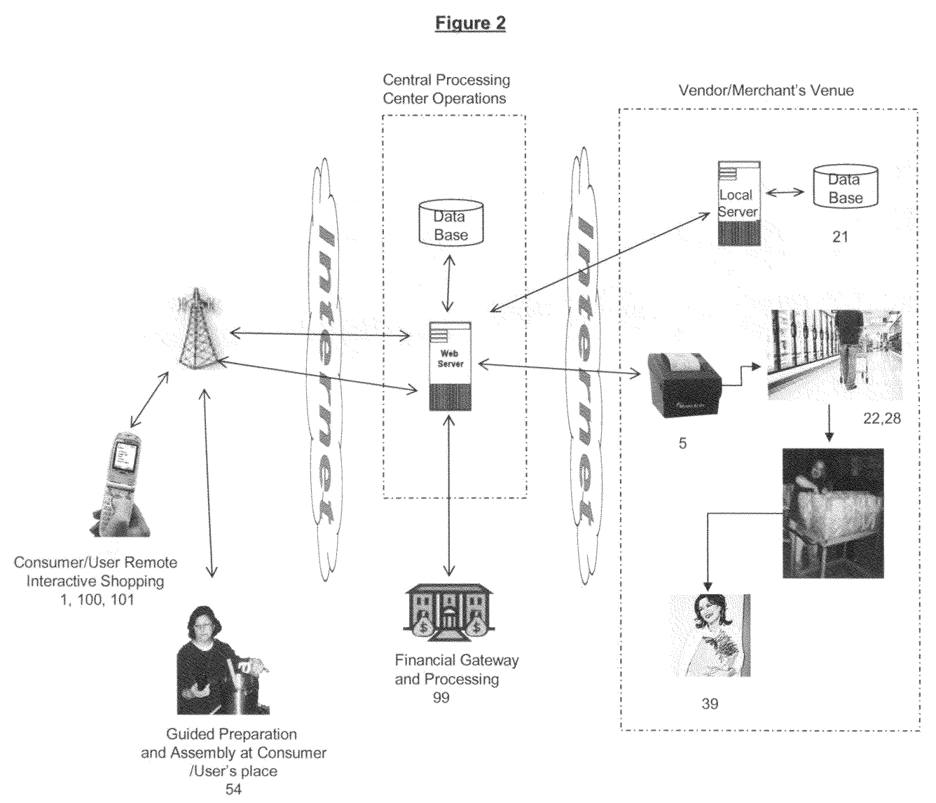

The description for the embodiments is provided below in reference to FIGS. 1 and 2. A Consumer/User (1) launches the We-Shop application (2) related to a particular vendor/merchant (3) on his/her personal wireless communication device (100) or PC (101). The application may be automatically lunched on the user's device upon user getting in the proximity of the vendor, as the user may have been already registered with the vendor for such application.

Based on Consumer's/User's location, preferences, and desired venue, a venue-specific multi-criterion preference options list (30) is presented to the user from a Central Processing Server(s) (4).

Consumer/User (1) may select shopping criterion/criteria (31) (i.e., dinner for 4+low calories+low sodium+under $15 per person+Seafood+Kosher+under 30 minute preparation; or, Halloween costume+for girls+under 9 years+under $20+easy to assemble).

Based on the selected combination of criterion/criteria, the Central Processing Server(s) may present a list of optional recipes/end-products (32) to consumer's handset or PC. (i.e., Broiled Salmon, Salmon Fettuccini, Paella; or, costumes of Cinderella, Red Riding Hood or Sorcerer). Consumer/User (1) may select a desired recipe/assembly (33).

The Central Processing Server(s) (4) may present a list of the needed ingredients/components (34) for the selected recipe/assembly to the Consumer/User's handset or PC.

From the list (34), Consumer/User (1) may select item(s)/ingredient(s) that he/she does not already have (24a) (e.g., salt and pepper are often part of food recipes, yet they are available at most homes and, therefore; would not be needed/selected at each shopping instance; or, glue or thread and needle might be available at a home and, therefore; would not be necessarily needed/selected for each new costume making). Selected item list (24a) is transmitted to the Central Processing Server(s) (4).

The Central Processing Server(s) may develop a suggested “Pick List” (24b). Pick List (24b) is a detailed item specific component/ingredient list that identifies each item by brand, size, price, and other item specifiers. The Pick List (24b) components may be based on historical shopping/usage pattern and brand preference from Vendor's Data Base (21) or WiShop Data Base (20) and/or Customer/User pre-defined “preferred list” (6) and/or item(s) availability at the vendor and/or the nearest size of item availability (i.e., a food recipe might call for a “Table Spoon” of butter but Grocers do not sell butter packages of less than 4 oz), and/or vendor promotions, etc.

The Pick List (24b) may also include related information (e.g., price, weight, calories, hazard index, Sodium content, etc.). The Pick list ( )24b) may also include “Suggested Add-on” list (35) that may be generated based on the Central Processing Server(s) Data Base (20) or Vendor's Data Base (21), based on the Consumer/User selected recipe/assembly and or Vendor's promotions. (i.e., matching wines, appetizers, and/or deserts for a meal or, complementary costume that would match a sibling or a friend) or other criteria.

The Pick List is transmitted to Consumer/User's handset or PC for approval. Upon Consumer/User's selection of some or all of the optional Suggested Add-ons, the modified Pick List (24b) is transmitted back to the Central Processing Server(s) (4).

Central Processing Server(s) (4) tallies the total and presents the Final Pick List (24) to the Consumer's/User's for review, approval and payment method selection (36).

Consumer/User (1) approves the final Pick List (24), or alternatively changes or modifies the Pick List (24b) by going back to modify the selected items (24a) or selected criteria (31).

Consumer/User (1) selects and approves a method of electronic payment through a pre-established We-Shop account, or Vendor account, entering credit card information, or selecting payment at the store. Upon Consumer/User's (1) final approval of the “Pick List” (24b) it is transmitted to the Central Processing Server(s) (4). Optionally, Consumer/User (1) can opt for Delivery and enter a Delivery Location (39) for Final Pick List (24) delivery.

Central Processing Server(s) (4) may also transmit a “Transaction Identifier” (51), “Package Pickup Location” (28) or Delivery time (53) to the Consumer/User's Personal wireless Communication Device (100) or PC (101).

In one embodiment Central Processing Server(s) (4) transmit a “location list” (29) identifying the specific location of each ingredients at the Vendor/Merchant (3) to Consumer/User's wireless device (101) for Consumer/User's expeditious guided retrieval of the Pick List (24) at the venue.

Central Processing Server(s) (4) may also provide a detailed guide and instructions (54) for preparation/assembly of the selected recipe/assembly to the Consumer/User (1). This information may be transmitted via text messaging and/or audio messaging and/or multimedia video messaging to consumer's wireless device to assist the Consumer/User (1) in preparation/assembly of the final food or project.

Central Processing Server(s) (4) may also send the Pick List information, that includes: A) Transaction Identifier (51); B) List of selected components (24); C) Individual item locations at the venue (29); D) The assigned location for Consumer/User package pickup (28), or alternatively the package delivery address (39) to a plug and play web connected announcing device, such as a printer (5) and/or a plug and play web connected visual display unit (5) at the venue. The plug and play web connected printer (5) and/or plug and play web connected visual display unit (5) could be a stand alone unit(s) or part of the Venue's Point of Sales System.

Vendor/Merchant Operators, may use the presented Pick List to gather the Final Pick List (24), pack them, and place them in the Pick Up area (28) for Consumer/User pickup, or alternatively for Vendor/Merchant delivery to the consumer.

In one embodiment, further information about the pick up location and/or pickup time is sent from the venue to the web server for transmission to the Consumer's/User's wireless handset, e.g., via Text, Audio or multimedia messaging.

What is claimed is:

1. A method for wireless interactive guided shopping, comprising:
providing a list of criterion for the selection;
allowing the user to make a selection on the criterion;
providing a list of recipes for the selection of the criterion;
allowing the user to make a selection on the list of recipes;
providing a list of suggested ingredients for the selection of the recipes;
allowing the user to make a selection on the ingredients;
allowing the user to select a method of payment for the selected ingredients; and
allowing the user to choose a method of pick up or delivery for the selected ingredients.

2. The method of claim 1, wherein the option list is based on the user's historical shopping/usage patterns, brand preference, vendor preference, user's predefined option list, availability, proximity, and/or promotional incentives.

3. The method of claim 1, wherein the list of ingredients further includes suggested add-on, such as a matching wine, appetizer, and/or dessert for the selection.

4. The method of claim 1, further comprising wirelessly providing instructions for preparing the recipe to the user; via text messaging, voice messaging, and/or multimedia messaging to the user's personal wireless handset.

5. The method of claim 1, further comprising providing the selection of the ingredients to a plug and play web-connected announcing device, such as a printer or a display unit in a merchant's or vendor's location.

6. The method of claim 1, further comprising wirelessly providing information about pickup location and time or delivery time to the user, via text messaging, voice messaging, email or multimedia messaging to the user's personal wireless handset.

7. The method of claim 1, further comprising wirelessly providing item location information within the venue for the selected ingredients to the user, via text messaging, voice messaging or multimedia messaging to the user's personal wireless handset.

8. An apparatus for wireless interactive guided shopping, comprising:
means for providing a list of criterion for the selection;
means for allowing the user to make a selection on the criterion;
means for providing a list of recipes for the selection of the criterion;
means for allowing the user to make a selection on the list of recipes;
means for providing a list of suggested ingredients for the selection of the recipes;
means for allowing the user to make a selection on the ingredients;
means for allowing the user to select a method of payment for the selected ingredients; and
means for allowing the user to choose a method of pick up or delivery for the selected ingredients.

9. A method for wireless interactive guided shopping, comprising:
receiving a list of criterion for the selection;
making a selection on the criterion;
receiving a list of recipes for the selection of the criterion;
making a selection on the list of recipes;
receiving a list of suggested ingredients for the selection of the recipes;
making a selection on the ingredients; g a method of payment for the selected ingredients; and
choosing a method of pick up or delivery for the selected ingredients.

10. The method of claim 9, wherein the option list is based on the user's historical shopping/usage patterns, brand preference, vendor preference, user's predefined option list, availability, proximity, and/or promotional incentives.

11. The method of claim 9, wherein the list of ingredients further includes suggested add-on, such as a matching wine, appetizer, and/or dessert for the selection.

12. The method of claim 9, further comprising wirelessly receiving instructions for preparing the recipe to the user; via text messaging, voice messaging and/or multimedia messaging to the user's personal wireless handset.

13. The method of claim 9, further comprising providing the selection of the ingredients to a plug and play web-connected announcing device, such as a printer or a display unit in a merchant's or vendor's location.

14. The method of claim 9, further comprising wirelessly receiving information about pickup location and time or delivery time to the user, via text messaging, voice messaging, email or multimedia messaging to the user's personal wireless handset.

15. The method of claim 9, further comprising wirelessly receiving item location information within the venue for the selected ingredients to the user, via text messaging, voice messaging or multimedia messaging to the user's personal wireless handset.

16. An apparatus for wireless interactive guided shopping, comprising:
means for receiving a list of criterion for the selection;
means for making a selection on the criterion;
means for receiving a list of recipes for the selection of the criterion;
means for making a selection on the list of recipes;
means for receiving a list of suggested ingredients for the selection of the recipes;
means for making a selection on the ingredients; g a method of payment for the selected ingredients; and
means for choosing a method of pick up or delivery for the selected ingredients.
